(19) United States
(12) Patent Application Publication
(10) Pub. No.: US 2012/0274586 A1
(43) Pub. Date: Nov. 1, 2012

(54) METHOD AND APPARATUS FOR INTEGRATING MULTIPLE APPLICATIONS ON A SINGLE TOUCH PANEL

(76) Inventors: Andrew SOUTHWORTH, Coppell, TX (US); James Jouett, Carrollton, TX (US)

(21) Appl. No.: 13/431,106

(22) Filed: Mar. 27, 2012

Related U.S. Application Data
(60) Provisional application No. 61/518,088, filed on Apr. 29, 2011.

(51) Int. Cl. G06F 3/041

(52) U.S. Cl. 345/173

(57) ABSTRACT

An operating room arrangement enables a central operating room control system having a central operating room controller, a central media router and a central touch panel to control a plurality of operating room devices including a remote touch panel controlled medical device having a medical device controller and a device touch panel. When the central operating room control system is placed in a touch panel controlled medical device operating mode, a device touch panel interface is provided through the media router for display as part of a video display image on the central touch panel, along with an additional indicia.

### CROSS REFERENCE TO RELATED APPLICATION

This claims the benefit of U.S. Provisional Application No. 61/518 088, filed Apr. 29, 2011, the disclosure of which is hereby incorporated by reference in its entirety.

### FIELD OF THE INVENTION

The present invention pertains to a central operating room control system having a central touch panel capable of acting as a device touch panel for a touch panel controlled medical device used in the operating room.

### BACKGROUND AND SUMMARY OF THE INVENTION

A single touch panel for controlling plural medical devices including multi-media devices in a surgical operating room minimizes the number of controllers required in the operating room. Eliminating the number of controllers maximizes the available work space in an operating room by reducing the number of control display devices provided in a sterile field or at another area of the operating room, whereby a single user at a single location is capable of controlling a plurality of medical devices. Thus, convenience is increased and time required to perform a surgery is reduced.

A single touch screen is known for controlling multiple medical devices. The arrangement, however, requires a processor of the control system to process the input commands and to provide appropriate outputs to control the selected devices. Further, the processor of the control system must determine and provide video signals to the touch panel to display different choices for selecting and routing various video signals to various video displays and for selecting and controlling medical devices.

The present invention is directed to a central operating room control system including a central touch panel, a central media router and a central operating room controller, wherein the central touch panel controls a plurality of operating room devices including a remote touch panel controlled medical device having a medical device controller and a device touch panel. The central operating room controller controls the central media router to display the operating room devices on the central touch panel for selection and control. The medical device controller provides device touch panel video signals to the device touch panel for display, and the device touch panel is configured for outputting device touch signals to the medical device controller to control the medical device in response to the touch signals. The central media router is connected to a video output of the touch panel controlled medical device for receiving device touch panel interfaces as video signals from the touch panel controlled medical device.

In response to a user selecting the touch panel controlled medical device from the display of operating room devices on the central touch panel, the central touch panel provides central touch signals to the central operating room controller that place the central operating room control system into a touch panel controlled medical device operating mode. In this operating mode, the central media router receives a medical device touch panel interface from the touch panel controlled medical device that is routed to and displayed as part of a video display image on the central touch panel. Thus, the central operating room controller does not output or determine the complete video display image provided by the central media router to the central touch panel. Instead, the central operating room controller places an exit indicia or marking onto or with the device touch panel interface received from the touch panel controlled medical device by the central media router, which are displayed as a video display image on the central touch panel. If a user touches the exit indicia or marking on the video display image, the central operating room controller cancels the touch panel controlled medical device operating mode and returns to an initial touch panel interface. When a user touches other buttons or markings on the central touch panel in the touch panel controlled medical device operating mode, the central operating room controller passes the central touch signals received from the central touch panel without modification to the touch panel controlled medical device and the touch panel controlled medical device processes the unmodified central touch signals for control thereof.

Still further, the invention provides the medical touch panel interface as video signals from a remote touch panel controlled device to a central touch panel so that a central operating room controller of a central operating room control system does not need to store the various video images of the remote touch panel controlled device, much less provide the video images to the central media router. In such an arrangement, memory and control functions of the remote touch panel controlled medical device are not performed by the central operating room controller, which enables a processor of the central controller to perform other functions in a timely manner.

### BRIEF DESCRIPTION OF THE DRAWINGS

FIG. 1 is a block diagram of a central operating room control system in combination with operating room devices according to one embodiment of the invention.

FIG. 2 shows an initial central touch panel interface or video image for display on a central touch panel.

FIG. 3 shows a touch panel device selection interface for display on the central touch panel.

FIG. 4 shows a medical device touch panel interface for display on a remote device touch panel.

FIG. 5 shows a video display image including the device touch panel interface shown in FIG. 4 and indicia, which are displayed on the central touch panel.

FIG. 6 is a block diagram of a central operating room control system in combination with plural remote touch panel controlled medical devices according to an embodiment of the invention.

### DETAILED DESCRIPTION OF THE INVENTION

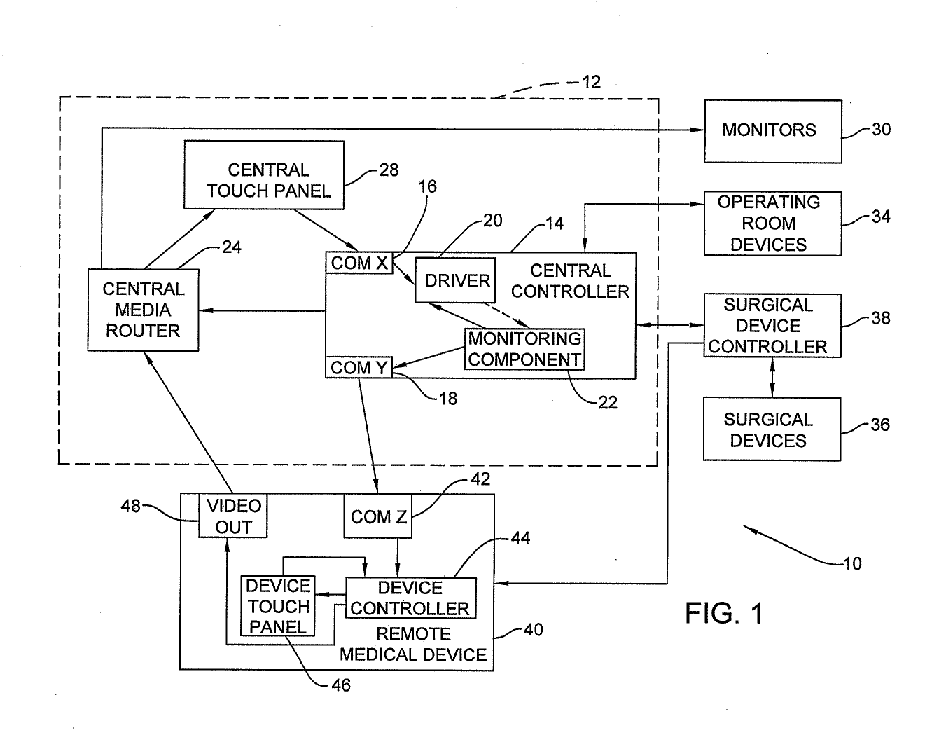

FIG. 1 depicts a block diagram of an operating room arrangement 10 according to one embodiment of the present invention. The operating room arrangement 10 includes a central operating room control system 12 including a central operating room controller 14, a central media router 24 and a central touch panel 28. In one embodiment, the central touch panel 28 is an ELO® touch monitor sold by Elo® TouchSystems of Menlo Park, Calif.

The central operating room controller 14 includes a COM X port 16, i.e. communication port, and a COM Y port 18. The central operating room controller 14 further includes a driver 20 and a monitoring component 22. The driver 20 is an ELO® driver in the embodiment having the central touch panel 28 as an ELO® touch panel. The central operating room controller 14 provides video and control signals to the central media router 24. The central media router 24 provides a selected media output, such as video signals, to the central touch panel 28. Central touch signals output from the central touch panel 28 are provided to COM X port 16 of the central operating room controller 14.

In one embodiment, the central operating room control system 12 is provided by a central operating room controller 14 disposed in a first housing and connected to a central media router 24 provided in a second separate housing. A separate stand-alone central touch panel 28 is connected to the media router 24 and to the central operating room controller 14.

The embodiment of FIG. 1 includes monitors 30 that receive video signals output from the central media router 24 for display thereon. The operating room arrangement 10 includes operating room devices 34 that are connected to the central operating room controller 14. Such operating room devices 34 include, but are not limited to room cameras, room lights, climate control, a navigation personal computer, an auxiliary computer and a picture archiving and capture system personal computer.

The operating room arrangement further includes a plurality of operating room devices that are surgical devices 36, such as an endoscopic camera, an endoscopic light source, an endoscopic fluid source, an endoscopic suction device, an insufflator, shaver and powered cutting tools including RF energy electrodes. Additional endoscopic cutting tools include rotating cutting blades and other cutters. In some embodiments, a surgical device controller 38 connects the plurality of surgical devices 36 to the central operating room controller 14. The surgical device controller 38 assists the central touch panel 28 and the central operating room controller 14 with control of the surgical devices 36. One type of surgical device controller 38 is described in U.S. Pat. No. 7,366,934, the disclosure of which is hereby incorporated by reference.

In some embodiments, the operating room arrangement 10 includes a remote touch panel controlled medical device 40. Examples of such touch panel controlled medical devices include an image and video capture device, an annotator, and other operating room devices that include a device touch panel. Further it will be appreciated that the remote touch controlled medical device 40 can be any type of operating room device, such as any medical or surgical device that is provided with a device touch panel. The touch panel controlled medical device 40 includes a COM Z port 42, i.e. communication port, for receiving inputs that are provided to a device controller 44 of the medical device 40. Further, the touch panel controlled medical device 40 includes a device touch panel 46 that receives touch panel video signals from the device controller 44 for display thereon. The device touch panel 46 outputs device touch signals to the device controller 44. Further, the device controller 44 may provide touch panel video signals as a medical device touch panel interface to a video OUT port 48.

Use of the central operating room control system 12 requires that the central operating room controller 14 determine or be informed of the operating room devices 34, surgical devices 36 and remote touch panel controlled medical devices 40 connected thereto, along with available monitors 30 and any other devices for displaying video signals.

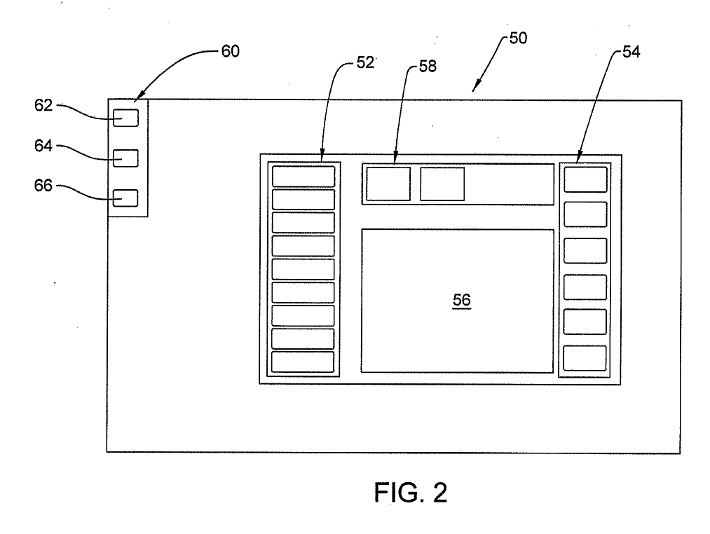

In some embodiments, at start-up the central touch panel 28 displays an initial touch panel interface or touch panel video image 50 as shown in FIG. 2 having a plurality of icons, markings or buttons for selectively routing various video signals to various monitors 30 or other display devices for display, as well as for selecting various devices to be controlled. In FIG. 2, a group of routing video sources shown as boxes or buttons 52 correspond to various source devices that output media, such as video images for display or the central touch panel 28. The buttons 52 provided on the central touch panel 28 have indicia, symbols or markings (not shown) that identify for routing one or more of surgical video signals provided by an endoscopic camera, images from a remote video conferencing system, recorded video obtained from a remote archive server, a quad view of four different images provided as a single video image, video images from a room camera in an operating room, patient information or data, and other types of video displayed information.

Video display destinations are shown as boxes or buttons 54 having indicia or markings (not shown) on the touch panel interface 50 of FIG. 2. The video destinations to be selected include one or more of the monitors 30, a monitor at a distant remote site for teleconferencing, a video hub, and other devices for displaying one or more of the various video images or video signals discussed above. The arrangement allows the selection and simultaneous viewing of multiple video images from one or more video sources at multiple destinations.

The touch panel interface 50 shown in FIG. 2 includes a video preview region 56 wherein video signals or video images, for example the video images from an endoscopic camera, are displayed for various purposes.

In FIG. 2, operating room device buttons 58 with indicia or markings (not shown) can select, for example, an image and video capture device. Other of the above-mentioned devices having a touch panel can be selected with the buttons 58 on the initial touch panel interface 50 displayed on the central touch panel 28.

The start up or initial touch panel interface 50 shown in FIG. 2 includes menu buttons 60 with indicia (not shown) in the upper left corner that include a home button 62 for returning to the initial start up touch panel interface 50 shown in FIG. 2, a preset button 64 related to providing presets for operation of the central operating room control system 12, and a device control button 66 for providing a touch panel device selection interface or selection display of operating room devices on the central touch panel 28 for selection and control.

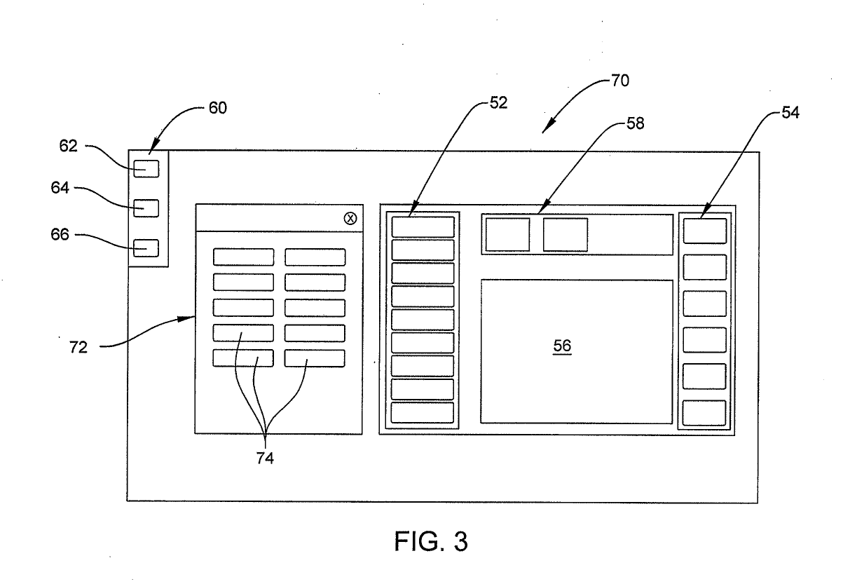

Upon actuation of the device control button 66, the central touch panel 28 provides a central touch signal to the central operating room controller 14. In response to selection of the device controls button 66 on the touch panel, the central operating room controller 14 provide control and video signals to the central media router 24 that result in the display of the touch panel device selection interface or device selection video image 70 shown in FIG. 3 being displayed on the central touch panel 28. The touch panel device selection interface 70 includes essentially all of the buttons 52, 54, 58, 62, 64, 66 and the image preview feature 56 shown in FIG. 2, along with an additional control panel section 72. The control panel section 72 includes a plurality of device selection buttons 74 having indicia or markings (not shown) for selection of the above described operating room devices 34, including surgical devices 36 and medical devices 40. Actuating a climate control selection button 74 having indicia (not shown), for example, results in a new touch panel interface (not shown) provided by the central operating room controller 14 and displayed on the central touch panel 28 that includes buttons which allow a user to control climate conditions in an operating room by touching the central touch panel. Other touch panel interfaces provided in response to touching of other device selection buttons 74 function in a similar manner. Thus, the buttons 74 displayed on central touch panel 28 are capable of selecting and controlling various operating room devices 34, including medical and surgical devices 36, 40. At any time during the above described operations, a user may press home button 62 illustrated in FIGS. 2 and 3 to return to the home or initial touch panel interface 50 shown in FIG. 2.

In one embodiment of the invention, the central touch panel 28 is an ELO® touch panel. When an operating room device or task is selected using the central touch panel 28, central ELO® touch signals from the central touch panel 28 are provided to an ELO® driver 20 of the central operating room controller via COM X port 16. ELO® driver 20 receives the central touch signals and provides the signals in a proper format for processing by the central controller 14. In response to the central touch signals, the central controller 14 may control central media router 24 to provide video signals or video images from a selected video source to a selected video destination. In response to central touch signals, the central controller 14 can determine and display a touch panel interface or video image for a particular operating room device, such as an operating room device 34 or a surgical device 36 to be controlled. The central controller 14 may output different selected video signals to the central media router 24 for display on the central touch panel 28. Thus, new touch panel interfaces or video display images are generated and displayed on the central touch panel 28 as necessary.

Plural touch panel interfaces or video signals for a specific operating room device, such as an endoscopic camera 36, may be considered part of an endoscopic camera operating mode. Corresponding operating room devices that have plural touch panel interfaces also are considered as having their own specific operating room device operating modes. In many embodiments, the touch panel interfaces for the various device operating modes are stored in memory and provided by the central operating room controller 14 to the central touch panel 28 for display via the central media router 24.

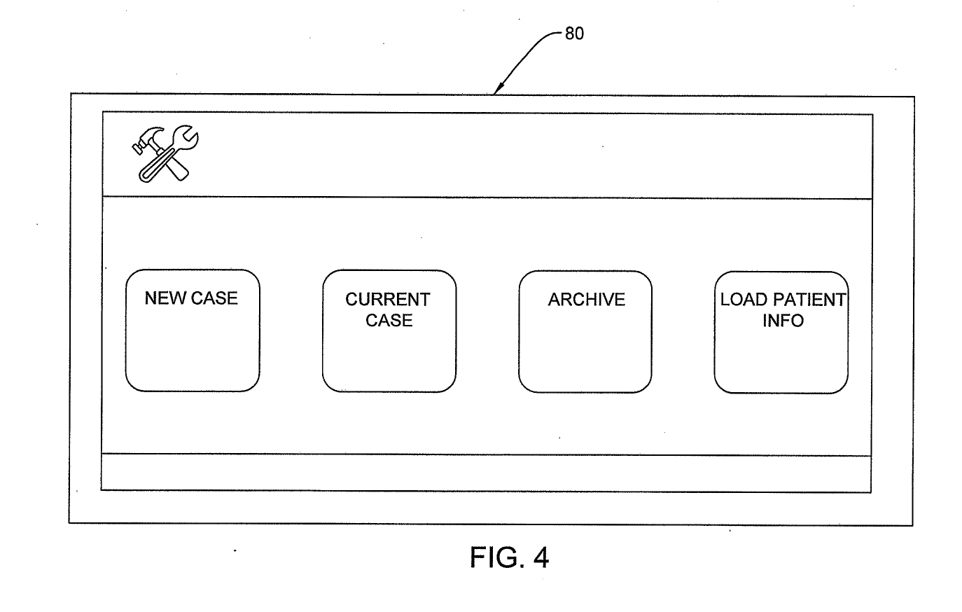

The various touch panel controlled medical devices 40 can be operated as stand alone devices, separately from the central operating room control system 12. In one embodiment, the remote touch panel controlled medical device 40 is an image and video capture device that may function as a stand-alone medical device having an initial start-up image and video capture device touch panel interface or device touch panel video signal 80 as shown in FIG. 4. In operation, the control selections shown in FIG. 4 include NEW CASE, CURRENT CASE, ARCHIVE and LOAD PATIENT INFO. The image and video capture device 40 is capable of selecting and archiving various images and loading patient information to identify and link captured images to particular patients and particular cases or procedures. Additional image or video capture touch panel interfaces (not shown) provide more options for a user. Further, in some image or video capture touch panel interfaces, the device touch panel 46 can display live video images, such as video signals of surgical procedures that are provided by an endoscopic camera.

### INTEGRATED TOUCH PANEL ARRANGEMENT

In many embodiments of the invention, the central operating room control system 12, after selection of a remote touch panel controlled medical device 40 with the central touch panel 28, is capable of displaying the medical device touch panel video signals or medical device touch panel interface 80 of the touch panel controlled medical device 40 on the central touch panel 28. Thus, selection of the touch panel controlled medical device 40 places the central operating room control system 12 into a touch panel controlled medical device operating mode.

In one embodiment, the selection of the remote touch panel controlled medical device 40 by the central operating room control system 12 also requires a manual input to the device touch panel 46 of the remote touch panel controlled medical device 40, whereby the device controller 44 provides the medical device touch panel interface or device touch panel video signals for the device touch panel 46 to video OUT port 48. The video OUT port 48 is initially connected to the central media router 24 of the central operating room control system 12. In one embodiment, the video OUT port 48 continuously provides video signals to the central media router 24 that are ignored, except when the touch panel controlled medical device 40 is selected by the central operating room control system 12. In one embodiment, the device controller 44 provides a darkened non-displaying image as the medical device touch panel video signal to the device touch panel 46. Further, in some embodiments, a manual input on the device touch panel 46 is required so that the touch panel controlled medical device 40 recognizes that the signals received at COM Z port 42 are central touch signals from an ELO® device for processing by an ELO® driver (not shown) provided therein. In one embodiment, the device touch panel 46 is viewable and capable of controlling the medical device 40 in combination with the central touch panel 28. In another embodiment, upon selection of the touch panel controlled medical device operating mode, the central operating room controller 14 provides control signals to the touch panel controlled medical device 40 via COM Z port 42 that automatically places the touch panel controlled medical device 40 into the touch panel controlled medical device operating mode for external control, wherein only central touch signals received at the COM Z port from the central operating room controller 14 control the touch panel controlled medical device 40.

More specifically, upon the central operating room control system 12 having selected the touch panel controlled medical device 40 and the remote touch panel controlled medical device placed into the touch panel controlled medical device operating mode manually by the user or automatically, the medical device touch panel interface 80 or video signal is output from video OUT port 48 and received by the central media router 24. The medical device touch panel interface 80 is routed by the central media router 24 to the central touch panel 28.

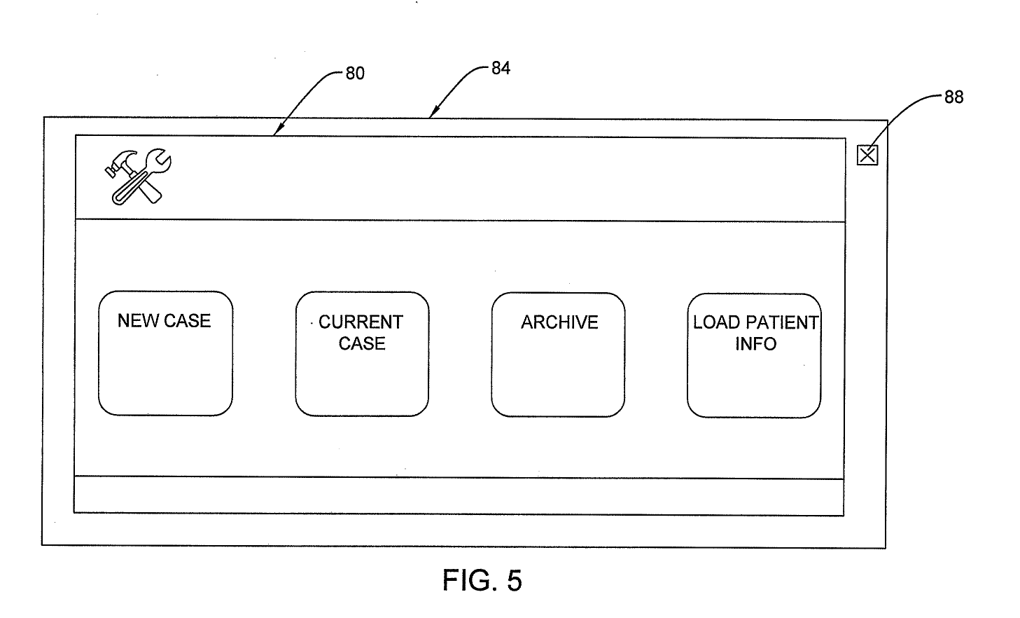

Continuing with the operation of the central operating room control system in the touch panel controlled medical device operating mode, when the remote touch panel controlled device 40 is an image and video capture device, the device touch panel interface 80 shown in FIG. 4 is the video signal provided through the central media router 24 to the central touch panel 28 in the manner discussed above. The device touch panel interface 80 is displayed as part of a video display image 84 on the central touch panel 28. More specifically, as shown in FIG. 5 indicia 88 shown as an “X” in the upper right corner of the central touch panel 28 is displayed in combination with the device touch panel interface 80 corresponding to the video image for the device touch panel 46. Thus, FIG. 5 shows the device touch panel interface 80 disposed within the dimensions of the video display image 84 provided on the central touch panel 28, along with indicia 88 spaced outwardly from the device touch panel interface 80. The purpose of the indicia 88 or marking provided as part of the video display image on the central touch panel 26 is as follows.

Upon touching any of the labeled input buttons shown in FIG. 5 that are displayed on the central touch panel 28, the central touch panel 28 outputs a central ELO® touch signal to the COM X port 16 of the central operating room controller 14. In this image and video capture device operating mode, the ELO® driver 20 and monitoring component 22 of the central operating room controller 14 only determine whether the indicia 88 in the upper right hand corner of the central touch panel 28 is the central ELO® touch signal received. If the central operating room controller 14 determines the indicia 88 was touched, the central operating room controller 14 exits the image and video capture device operating mode. Thus, when selected, indicia 88 acts as an exit command.

If the central operating room controller 14 determines the central touch signal was not sensed at the location of indicia 88, the monitoring component 22 outputs the central ELO® touch signal from COM Y port 18 in its original form without modification. The unmodified central ELO® touch signal is received by the image and video capture device 40 at COM Z port 42. An ELO® driver (not shown) provided in the image and video capture device 40 then provides output drive signals to the device controller 44. The output drive signals are utilized to control the image and video capture device 40 in essentially the same manner as device touch signals provided to the device controller 44 by the device touch panel 46.

By providing the pass through of central ELO® touch signals from the central touch panel 28 to the image and video capture device 40 without modification, and separately providing the medical device touch panel interface 80 from the image and video capture device 40 to the central media router 24, the central operating room controller 14 requires less signal processing in this operating mode, and thus is capable of executing other functions. Therefore, the arrangement minimizes the processing time required by the central operating room controller 14 when the central touch panel 28 is assigned to the image and video capture device or to a different touch panel controlled medical device 40.

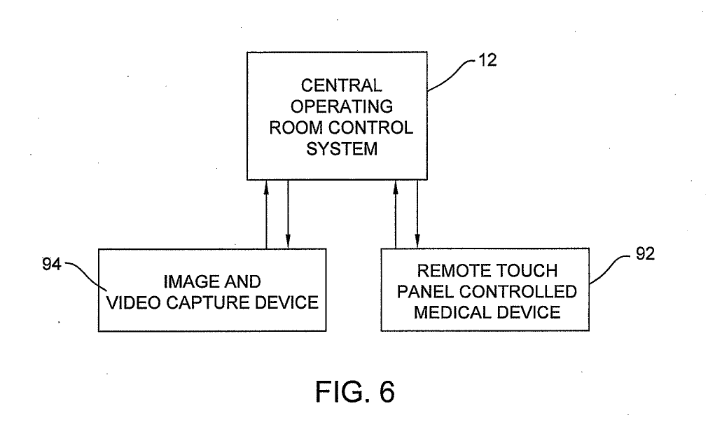

In the embodiment shown in FIG. 6, the central operating room control system 12 is connected to a remote touch panel controlled medical device 92 and to an image and video capture device 94 having a touch panel. As in the embodiments discussed above, the central operating room control system 12 is operated so that central touch signals from the central touch panel 28 can select either the touch panel controlled medical device 92 or the image and video capture device 94 for operation. The selection is typically performed by one of the buttons 58 provided on the touch panel interfaces shown in FIGS. 2 and 3. After selection of one of the two devices 92, 94 by the central controller 14, the selected device having a touch panel is placed in the operating mode in the manner discussed above. Thus, plural touch panel controlled medical devices 92, 94 can be selected by a user for operation.

The block diagram of FIG. 1 shows arrows for connecting various devices. In some embodiments, the connections are wired signal paths, but in other instances the connections are provided as wireless signal paths. In some embodiments, the central touch panel 28 provides central touch signals as RS-232 signals to the COM X port 16 and the COM Y port 18 provides central touch signals as RS-232 signals to the COM Z port.

While FIG. 1 shows the COM X port 16 and the COM Z port 42 acting only as input ports, in some embodiments the ports 16, 42 also function at least as low level output ports to provide bi-directional communication. Further, COM Y port 18 may function at least as a low level input port in some embodiments. Thus, bi-directional communication can be provided between COM Y port 18 and COM Z port 42. Such bi-directional communication, for example, may allow the central controller 14 to identify the presence of a touch panel controlled medical device 40 connected to COM Y port 18.

The embodiments described above mainly discuss the routing of video signals through the central media router 24. In some embodiments, audio signals alone or audio signals in combination with corresponding video signals, are routed by the central media router 24. Audio signals can be routed to audio speakers (not shown) provided within or near the monitors 30, to a monitor combined with speakers at a distant remote site for teleconferencing, and to other devices for providing audio output.

While the above embodiments disclose the use of an ELO® central touch panel 28 and an ELO® driver 20, other types of touch panels with other touch panel signal formats are contemplated by the invention. Further, in some embodiments the device touch panel 46 of the remote medical device 40 can be the same type of touch panel as the central touch panel 28. In such an embodiment, an ELO® driver or other type of driver is not required for the remote touch panel controlled medical device 40.

In one embodiment, the image and video capture device 94 is connected to a picture archive communication storage system, a remote patient information server and a printer.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. An operating room arrangement for control of operating room devices, the arrangement comprising:
a plurality of operating room devices to be controlled, the operating room devices including at least one remote touch panel controlled medical device, said touch panel controlled medical device comprising a medical device controller and a device touch panel, said medical device controller providing device touch panel video signals to the device touch panel for display, and said device touch panel configured for outputting device touch signals to said medical device controller to control said touch panel controlled medical device in response to touches by a user; and
a central operating room control system including a central operating room controller connected to the plurality of operating room devices, a central media router and a central touch panel, wherein the central operating room controller is connected to the central media router and to the touch panel controlled medical device, and the central media router is connected to the central touch panel and to a video output of the touch panel controlled medical device for receiving a medical device touch panel interface from said touch panel controlled medical device,
wherein the central operating room controller controls the central media router to display the operating room devices on the central touch panel for selection and control so that, in response to a user selecting the touch panel controlled medical device from the display of operating room devices using the central touch panel, the central touch panel provides central touch signals to the central operating room controller to place the central operating room control system into a touch panel controlled medical device operating mode, and in the touch panel controlled medical device operating mode, the central media router receives a medical device touch panel interface from the touch panel controlled medical device that is routed to and displayed as part of a video display image on the central touch panel.

2. The arrangement according to claim 1, wherein in the touch panel controlled medical device operating mode the central operating room controller receives central touch signals from the central touch panel and passes the central touch signals without modification to the touch panel controlled medical device so that the touch panel controlled medical device processes the unmodified touch signals for control thereof.

3. The arrangement according to claim 2, wherein to enter the touch panel controlled medical device operating mode, the touch panel controlled medical device requires a manual input to discontinue the device touch panel video signals to the device touch panel and to provide the medical device touch panel interface to the central media router.

4. The arrangement according to claim 2, wherein the touch panel controlled medical device comprises an image and video capture device that is configured to selectively display video images of a patient onto the device touch panel, and wherein the central operating room control system is configured to selectively display video images of the patient on the central touch panel or onto a monitor connected to the central operating room control system.

5. The arrangement according to claim 2, wherein the video display image displayed on the central touch panel in the touch panel controlled medical device operating mode comprises the medical device touch panel interface from the touch panel controlled medical device and at least one additional indicia or marking disposed outwardly from the part of the video display image corresponding to the medical device touch panel interface.

6. The arrangement according to claim 5, wherein touching of the additional indicia on the video display image displayed on the central touch panel in the touch panel controlled medical device operating mode outputs a central touch signal that the central operating room controller determines is an exit signal, wherein in response to the exit signal the central operating room controller discontinues the passage of central touch signals to the touch panel controlled medical device and controls the central media router to display the operating room devices on the central touch panel for selection and control.

7. The arrangement according to claim 6, wherein the central operating room controller includes a driver and monitoring component to determine the absence of an exit signal and enable the passing of the central touch signals to the touch panel controlled medical device without modification.

8. The arrangement according to claim 7, wherein the device touch panel of said touch panel controlled medical device and the central touch panel each output touch signals having the same format.

9. The arrangement according to claim 2, wherein the touch panel controlled medical device comprises a first touch panel controlled medical device and the plurality of operating room devices further comprises a second touch panel controlled medical device, the second touch panel controlled medical device being connected to the central media router to provide a medical device touch panel interface thereto and connected to the central operating room controller to receive central touch signals therefrom when the central operating room control system is operating in a second touch panel controlled medical device operating mode.

10. The arrangement according to claim 2, wherein said plurality of operating room devices to be controlled comprise at least three of room lights, room cameras, room climate control, an endoscopic camera, an insufflator, an arthroscopic pump, an endoscopic light source, a picture archive communication storage system, and a navigation personal computer.

11. A method for controlling operating room devices in an operating room, comprising:
providing a plurality of operating room devices to be controlled;
providing a central operating room control system including a central operating room controller connected to a central media router, a central touch panel connected to receive a video signal from the central media router and to provide a touch signal to the central operating room controller;
displaying plural ones of the operating room devices on the central touch panel for selection and control, the plurality of operating room devices to be controlled including at least one touch panel controlled medical device having a device touch panel for inputting device touch signals for control thereof, the touch panel controlled medical device configured to receive signals from the central operating controller and configured to send a medical device touch panel interface to the media router;
touching the central touch panel to select the touch panel controlled medical device from the operating room devices displayed on the central touch panel so that the central operating room control system is placed in a touch panel controlled medical device operating mode and the touch panel controlled medical device provides the medical device touch panel interface to the media router for routing to the central touch panel; and
displaying the medical device touch panel interface as part of a video display image on the central touch panel in response to the selection of the touch panel controlled medical device.

12. The method according to claim 11, including the step of touching the medical device touch panel interface displayed on the central touch panel to output central touch signals to the central operating controller, the central operating controller receiving the central touch signals and passing the central touch signals without modification to the touch panel controlled medical device so that the touch panel controlled medical device processes the unmodified central touch signals for control of said touch panel controlled medical device.

13. The method according to claim 12, including manually activating the device touch panel of the touch panel controlled medical device to provide the medical device touch panel interface to the central media router and to place the touch panel controlled medical device in the touch panel controlled medical device operating mode.

14. The method according to claim 12, wherein the touch panel controlled medical device is an image and video capture device.

15. The method according to claim 12, wherein displaying of a part of the video display image of the device touch panel on the central touch panel results in a video display image on the central touch panel that is essentially identical to the medical device touch panel interface, except for at least one additional indicia.

16. The method according to claim 15, including the steps of touching the additional indicia on the video display image to provide a central touch signal to the central operating room controller, determining that the central touch signal is an exit signal with the central operating room controller, in response to the exit signal discontinuing the passage of device touch signals from the central operating room controller to the touch panel controlled medical device exiting the touch panel controlled medical device operating mode and changing the video display image displayed on the central touch panel to display the operating room devices for selection and control.

17. The method according to claim 12, wherein the central operating room controller includes a driver and a monitoring component for receiving central touch signals and determining the presence of an exit signal, and wherein the central operating room controller prevents the passing of central touch signals to the touch panel controlled medical device in response to the exit signal.

18. The method according to claim 12, wherein the touch panel controlled medical device comprises a first touch panel controlled medical device and including the steps of providing a second touch panel controlled medical device having a video output connected to the central media router and connecting the second touch controlled panel device to the central operating room controller.

19. The method according to claim 12, including providing the plurality of operating room devices to be controlled with at least three of: room lights, room cameras, a room climate control, an endoscopic camera, an insufflator, an arthroscopic pump, an endoscopic light source, an image and video capture device, a picture archive communication storage system, and a navigation personal computer.
